(19) United States
(12) Patent Application Publication
(10) Pub. No.: US 2020/0334606 A1
(43) Pub. Date: Oct. 22, 2020

(54) LIQUID SALES MANAGEMENT SYSTEM

(71) Applicants: Asahi Group Holdings, Ltd., Tokyo (JP); ASAHI BREWERIES, LTD., Tokyo (JP)

(72) Inventors: Naoyuki YAMASHITA, Kashiwa-shi, Chiba (JP); Junichi KITANO, Kawaguchi-shi, Saitama (JP); Takashi WADA, Kobe-shi, Hyogo (JP); Kenji KUSUNOKI, Kobe-shi, Hyogo (JP)

(21) Appl. No.: 16/959,006

(22) PCT Filed: Nov. 30, 2018
(86) PCT No.: PCT/JP2018/044275

§ 371 Date: Jun. 29, 2020

(30) Foreign Application Priority Data
Jan. 4, 2018 (JP) 2018-000044

(51) Int. Cl. G06Q 10/06; B67D 1/08

(52) U.S. Cl. CPC G06Q 10/06315; B67D 1/0855

(57) ABSTRACT

There is provided a liquid sales management system that includes a liquid supply system and a sales information management system in a store, and a management server that performs information communication with the liquid supply system and the sales information management system. The liquid supply system includes a dispensing device that dispenses a liquid to a drinking container, an actual flow rate preparation part that determines an actual measured flow rate of the liquid dispensed into the drinking container from the dispensing device, and a transmission and reception part. The sales information management system is a system that sends sales information to a communication line. The management server includes a consumption analysis part that determines a difference between an apparent liquid amount and the actual measured flow rate, as a non-sale amount of the liquid.

### TECHNICAL FIELD

The present invention relates to a liquid sales management system that manages sales of a liquid in a liquid supply system.

### BACKGROUND ART

In a restaurant, a liquid supply system is generally used as a device for providing a liquid, for example, beer. When the beer is used as an example, the liquid supply system includes a carbon dioxide gas cylinder, a beer barrel filled with beer, a supply pipe, and a beer dispenser. The liquid supply system pressurizes the beer within the beer barrel with a carbon dioxide gas of the carbon dioxide gas cylinder, and transfers the liquid with pressurization from the supply pipe to the beer dispenser. The beer dispenser has a beer cooling pipe provided within a cooling tank, a refrigeration machine, and a dispensing outlet. The beer dispenser freezes a part of a cooling water within the cooling tank by the refrigeration machine, cools the beer while causing the beer to flow within the beer cooling pipe by a lever operation at the dispensing outlet, and dispenses the beer to a drinking container such as a beer mug. In this manner, the beer within the beer barrel is provided to a customer.

Many restaurants adopt a so-called point of sales system (POS) system as a system for managing sales information. The POS system is a system that acquires and transmits the sales information and the like when, for example, a customer pays a fee. Thus, for example, the sales amount of beer can be recorded together with time information of month, day, hour, and minute by using the POS system.

### PRIOR ART DOCUMENTS

### Patent Documents

Patent Document 1: JP 2001-229466 A

Patent Document 2: JP 5963587B

### SUMMARY OF THE INVENTION

### Problems to be Solved by the Invention

It is possible to manage sales information on an account book, in other words, nominal or apparent sales information by using the POS system as described above. That is, for example, information indicating that two medium beer mugs of beer are sold at 20:00 can be recorded. Here, when a prescribed capacity of one medium beer mug is decided to be 300 ml, 600 ml of beer is consumed at the aforementioned time on the sales information in the POS system. However, for example, if a staff in the restaurant spills the beer while pouring the beer into the first beer mug, for example, 330 ml of beer is actually consumed, and 630 ml of beer is actually consumed.

As described above, the fact is that the apparent sales information in the POS system may not match up with the actual consumption.

However, heretofore, the sales management of the liquid is not performed by focusing on the difference between the sales information in the POS system and the actual consumption.

The Patent Document 1 discloses that the remaining amount of a drink is managed by using a POS system in a restaurant, and the Document 1 fails to teach the content of comparing apparent information with actual information.

The Patent Document 2 discloses that state information of beverage is transmitted from a transmission device to a communication line, and is monitored by an external computer. So, the Patent Document 2 also fails to teach the content of comparing apparent information and actual information.

The present invention has been made in order to solve such problems, and an object of the present invention is to provide a liquid sales management system that performs sales management of a liquid by focusing on a difference between sales information and an actual liquid consumption.

### Means for Solving the Problems

To achieve the aforementioned object, the present invention has a configuration to be described below.

That is, a liquid sales management system according to an aspect of the present invention is a system comprising a liquid supply system in a store, a sales information management system in the store, and a management server communicating with the liquid supply system and the sales information management system via a communication line,

the liquid supply system including:

a dispensing device configured such that a liquid within a storage container is supplied with pressurization through a supply pipe, configured to cool and dispense the liquid to a drinking container;

an actual flow rate preparation part configured to have a flow rate sensor detecting an amount of the liquid dispensed into the drinking container and to determine a actual measured flow rate of the liquid dispensed into the drinking container from the dispensing device; and

a transmission and reception part configured to communicate with the communication line,

the sales information management system corresponding to a system configured to send sales information of the liquid to the communication line, the sales information being information with which pieces of information of a sales unit capacity corresponding to a prescribed capacity per one sale, the number of sales, and a sales time are associated, and

the management server including a consumption analysis part configured to determine a difference between an apparent, liquid amount determined from the sales information and the actual measured flow rate, the difference corresponding to a non-sales amount of the liquid which is not involved in sales.

### Effects of the Invention

The management server communicating with the liquid supply system and the liquid sales management system includes the consumption analysis part. Thus, the management server can recognize the difference between the sales information and the actual liquid consumption. As a result, for example, it is possible to compare the actual dispensed amount with respect to the prescribed capacity of one drinking container, and it is possible, for example, to ascertain the non-sale amount of the liquid in one business day.

### BRIEF DESCRIPTION OF THE DRAWINGS

FIG. 1 is a block diagram illustrating a basic configuration of a liquid sales management system according to a first embodiment of the present invention.

FIG. 2 is a block diagram illustrating a detailed configuration of a consumption analysis part illustrated in FIG. 1.

FIG. 3 is a block diagram illustrating a configuration of a liquid sales management system according to a second embodiment of the present invention.

FIG. 4A is a perspective view illustrating a detection part included in a fluid flow path adjustment device provided in the liquid sales management system illustrated in FIG. 3.

FIG. 4B is a diagram illustrating a schematic configuration of the fluid flow path adjustment device illustrated in FIG. 4A.

FIG. 4C is a diagram for describing a schematic configuration and operation of a fluid stopper device included in the fluid flow path adjustment device illustrated in FIG. 4A.

FIG. 4D is a diagram for describing a schematic configuration and operation of the fluid stopper device included in the fluid flow path adjustment device illustrated in FIG. 4A.

### EMBODIMENTS OF THE INVENTION

A liquid sales management system according to an embodiment of the present invention will be described below with reference to the drawings. In the drawings, the same or similar components arc denoted by the same reference symbols, in order to avoid the following description from being unnecessarily redundant and to facilitate the understanding of those skilled in the art, detailed description of well-known matters and redundant description of substantially the same configuration may be omitted. The following description and the contents of the accompanying drawings are not intended to limit the subject matter described in the claims.

The liquid sales management system according to each of embodiments to be described below includes a liquid supply system in a store such as a restaurant, a sales information management system in the store, and a management server that performs information communication with the liquid supply system and the sales information management system via a communication line.

In the following embodiment, beer is used as an example of a liquid to be handled, but the liquid is not limited to beer. Alcohol drinks such as low-malt beer, liqueur, shochu highball, whiskey, and wine, drinking water, sort drinks, and carbonated drinks may be used.

### First Embodiment

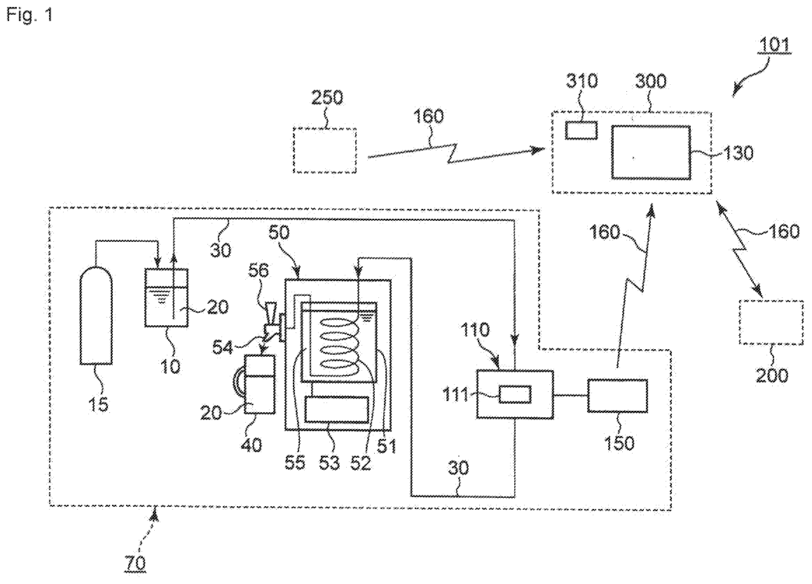

A liquid sales management system 101 according to a first embodiment illustrated in FIG. 1 will be described. The liquid sales management system 101 includes a liquid supply system 70, a sales information management system 250, and a management server 300 as described above, and is configured such that the management server 300 has a consumption analysis part 130 that determines a difference between sales information and an actual measured flow rate of a liquid 20, as will be described in detail below.

First, the liquid supply system 70 will be described.

As illustrated in FIG. 1, in the first embodiment the liquid supply system 70 has a configuration in which an actual flow rate preparation part 110 having a flow rate sensor 111 and a transmission and reception part 150 are further added to an existing basic component part including a storage container 10, a pressurization source 15, a supply pipe 30, and a dispensing device 50.

The basic component part is a system that supplies, that is, transfers the liquid (beer in the embodiment, as described above) 20 within the storage container 10 to the dispensing device 50 through the supply pipe 30 with pressurization by using the pressurization source 15 and dispenses the liquid from the dispensing device 50 to a drinking container (for example, a beer mug) 40. Here, in the embodiment, the storage container 10 is a stainless steel container called a beer barrel filled with beer in a beer manufacturer, and has a capacity of, for example, 5 liters, 10 liters, or 19 liters. The pressurization source 15 is a carbon dioxide gas cylinder. The supply pipe 30 is a flexible resin tube made of, for example, polyamide, polyurethane, or polyester which enables beer to flow between the storage container 10 and the dispensing device 50. As will be described below, a device included in the liquid sales management system 101 is attached to the supply pipe 30. It is preferable that inner diameters of flow passages of a fluid from the supply pipe 30 to a liquid dispensing outlet 54 in the dispensing device 50 are designed to have the same dimension such that a cleaning with a sponge becomes easy.

In the embodiment, a beer dispenser (may be referred to as a “beer server”) will be described as an example of the dispensing device 50 (hereinafter, may be accordingly referred to as the beer dispenser 50). As already described above, the beer dispenser 50 includes a liquid cooling pipe (beer cooling pipe in the embodiment) 52 disposed inside a cooling tank 51, a refrigeration machine 53, and the liquid dispensing outlet 54. The beer dispenser freezes a part of a cooling water 55 within the cooling tank 51 by using the refrigeration machine 53, and cools the liquid (beer) 20 passing through the beer cooling pipe 52 by using the cooling water 55. The beer 20 transferred by the pressurization source 15 passes through the beer cooling pipe 52 by operating a lever 56 at the dispensing outlet 54 while being cooled by heat exchange with the cooling pipe, is dispensed into the drinking container 40 such as the beer mug, and is provided to a customer.

The beer dispenser 50 is generally used in an environment in which an external air temperature is equal to or higher than 5° C. and is equal to or lower than 40° C. The liquid handled by the dispensing device 50 is not limited to the beer, and may be a drinking water. In the embodiment, the beer dispenser 50 cools the beer as a target liquid, but the dispensing device 50 included in the embodiment may also heat the target liquid or keep the target liquid warm.

In addition to the basic component part, the actual flow rate preparation part 110 which is an additional component has the flow rate sensor 111 that detects the amount of liquid dispensed into the drinking container 40, and the actual flow rate preparation part determines an actual measured (low rate of the liquid 20, for example, the beer in the first embodiment, dispensed into the drinking container 40 from the dispensing device 50 based on a detection signal of the flow rate sensor 111.

In the embodiment, the flow rate sensor 111 is installed at an appropriate position between an outlet of the storage container 10 and the beer dispenser 50 so as to sandwich the beer passing through the supply pipe 30. The installation position is not limited thereto, and the flow rate sensor may be attached to, for example, the supply pipe 30 of the dispensing device 50. In the embodiment, an ultrasonic sensor is used as the flow rate sensor 111. The actual flow rate preparation part 110 having such a flow rate sensor 111 determines the actual measured flow rate of the liquid (beer) actually dispensed into the drinking container 40 based on the signal obtained from the flow rate sensor 111.

The transmission and reception part 150 which is also the additional component is electrically connected to the actual flow rate preparation part 110. So, the transmission and reception part 150 can transmit the actual measured flow rate of the liquid 20 actually dispensed from the dispensing device 50 to the drinking container 40 that is, information on the actual consumption of the liquid 20 to the communication line 160, and can supply it to the management server 300: The transmission and reception part 150 can also receive information from the communication line 160.

Next, the sales information management system 250 will be described.

The sales information management system 250 is a system corresponding to a point of sales system (POS) system adopted in the store such as the restaurant. Here, the sales information management system 250 is the same as the system already described, and acquires sales information and the like, for example, at a time of a customer s payment, and supplies those to the management server 300 via the communication line 160. Here, the sales information of the liquid 20 corresponds to information with which pieces of information of a sales unit capacity that is a prescribed capacity per one sale, the number of sales, a sales time, and the like are associated. Here, the aforementioned “prescribed capacity per one sale”, that is, the “sales unit, capacity” corresponds to, for example, a capacity of one cup which is determined with respect to the drinking container 40 in each size. For example, it corresponds to a value of 300 ml in the case of a medium beer mug, a value of 500 ml in the case of a large beer mug. and the like. The “sales unit capacity” can be set by any of an input from the sales information management system 250, an input to the consumption analysis part 130 in the management server 300, and an input to an analysis device 200 to be described below, and can also be set for each of multiple types or volumes of drinking containers 40.

It is possible to record, for example, the sales amount of the liquid 20, for example, the beer together with time information of month, day, hour, and minute by using such a sales information management system 250. The acquisition of the sales information into the sales information management system 250 is not limited to at the time of payment, and may be at a time of inputting an order to a terminal carried by a store staff, or the like.

Next, the management server 300 will be described.

The management server 300 is constituted by a computer connected to the communication line 160, and corresponds to so-called cloud computing. In the embodiment, the management server 300 includes a storage part 310 that stores information supplied from the liquid supply system 70 and the sales information management system 250, and the consumption analysis part 130.

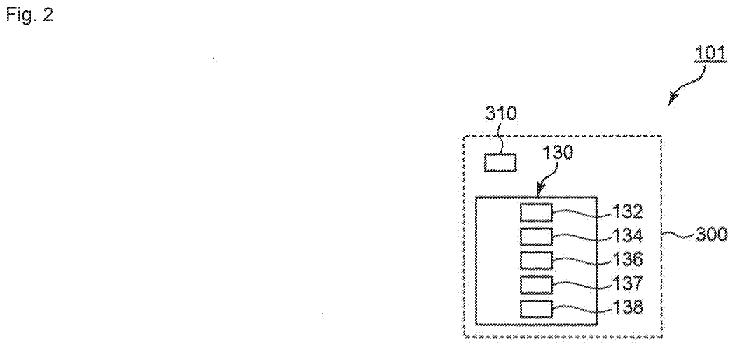

The consumption analysis part 130 in the management server 300 will be described below in detail with reference to FIG. 2.

The consumption analysis part 130 determines a difference between an apparent liquid amount of the liquid 20 obtained from the sales information supplied from the sales information management system 250 and the actual measured flow rate of the liquid 20 supplied from the actual flow rate preparation part 110 in the liquid supply system 70. Here, the “apparent liquid amount” corresponds to an apparent consumption of the liquid 20 that is not an actual measured value and is included in the sales information supplied from the sales information management system 250. Such an apparent liquid amount can be obtained by, for example, multiplying the sales unit capacity and the number of sales included in the sales information. Also, the apparent liquid amount corresponds to an apparent liquid amount, for example, during a time when the time information is identical or substantially identical, a set time, or a period such as one business day, each of which is included in the sales information.

In the present embodiment, the consumption analysis part 130 includes an apparent liquid amount acquisition part 137 that determines the apparent liquid amount, and a difference acquisition part 138 that determines a difference between the apparent liquid amount and tire actual measured flow rate. However, the present invention is not limited thereto, and for example, a value obtained from the sales information management system 250 may be used as the apparent liquid amount.

Regarding the actual measured How rate supplied from the actual flow rate preparation part 110 in the liquid supply system 70, the consumption analysis part 130 also determines the actual measured flow rate during the same period as the period during which the apparent liquid amount is determined, such as the set time, or one business day.

Further, the consumption analysis part 130 compares the obtained apparent liquid amount with the actual measured flow rate, and determines the difference therebetween. Usually, the actual measured flow rate tends to be larger than the apparent liquid amount. Thus, the amount of the liquid 20 corresponding to the obtained difference can be regarded as a non-sale amount of the liquid 20 which is not involved in the sales. Accordingly, reducing the non-sale amount is one of the important matters for each store in order to improve profit.

As described above, the time information along with the sales information is also supplied from the sales information management system 250 to the consumption analysis part 130 in the management server 300. However, since the consumption analysis part 130 requires the time information as described above, the consumption analysis part 130 can include a time information generation part 132. Here, the time information generation part 132 generates time information for the month, day, hour, and minute. Business hours information can be input to the consumption, analysis part 130, and the business hours information can be registered from the analysis device 200 that can perform information communication with the management server 300 via the communication line 160 and is provided in, for example, a manufacturing company of the liquid 20 (a beer manufacturer in the embodiment).

As described above, for example, a unit capacity error corresponding to the difference between the sales unit capacity of 300 ml, which is in an example of one medium beer mug, and the actual measured flow rate of the liquid 20 actually dispensed into the single drinking container 40 is one of matters that cannot be overlooked. That is, when the unit capacity error is larger on a plus side, since a capacity exceeding the prescribed capacity is provided to the customer, a loss on the store side is caused. Conversely, in a case where the unit capacity error is larger on a minus side, a loss on the customer side is caused. In the case of the beer, even though the beer mug is filled with beer, the difference between the sales unit capacity and the actual measured flow rate may be caused by depending on a ratio of the liquid and foam. So, also depending on how the beer is poured, the unit capacity error may occur.

Thus, the consumption analysis part 130 can include a unit capacity error acquisition part 134 as illustrated in FIG. 2. The unit capacity error acquisition part 134 determines an error between the sales unit capacity and the actual measured flow rate per one cup in the same period as the period, such as the set time, one business day, in which the apparent liquid amount is determined. Here, as for the actual measured flow rate per one cup, it is assumed that a flow rate during a continuous detection operation of the flow rate sensor 111 for one cup is set as the actual measured flow rate per one cup.

Further, from the viewpoint of hygiene management and quality control of the liquid 20 such as the beer, cleaning with water is usually performed within a pipeline from the outlet of the storage container 10 to the dispensing outlet 54 of the dispensing device 50 after the closing of business. Discarded amount and filled amount of the liquid 20 corresponding to a volume within the pipeline used according to this cleaning operation also become the non-sale amount.

Thus, the consumption analysis part 130 can include an overtime consumption acquisition part 136 as illustrated in FIG. 2. The overtime consumption acquisition part 136 determines an overtime consumption of the liquid 20 after the closing of the business with reference to the time information from the time information generation part 132 based on the actual measured flow rate obtained from the actual How rate preparation part 110.

The consumption analysis part 130 configured as above is realized by using a computer constituting the management server 300, the computer being configured with software for executing each of the aforementioned functions such as the apparent liquid amount acquisition part 137, the difference acquisition part 138, the time information generation part 132, the unit capacity error acquisition part 134, and the overtime consumption acquisition part 136; and a hardware such as a central processing unit (CPU) for executing the software and a memory (storage part 310).

The liquid sales management system 101 according to the embodiment having the configuration described above operates as follows.

In the liquid supply system 70, the store staff operates the lever 56 of the dispensing device (beer dispenser) 50, and thus, the liquid (beer) 20 is dispensed into the drinking container 40. The dispensed amount is measured by the actual flow rate preparation part 110, and is supplied as the actual measured flow rate from the transmission and reception part 150 to the consumption analysis part 130 of the management server 300 via the communication line 160.

The sales information with which pieces of information of the sales unit capacity, the number of sales, and the sales time are associated is also supplied to the management server 300 from the sales information management system 250.

In the present embodiment already described, the consumption analysis part 130 in the management server 300 determines the apparent liquid amount of the liquid 20 from the sales information supplied from the sales information management system 250, and further determines the difference between the actual measured flow rate of the liquid 20 supplied from the actual flow rate preparation part 110 in the liquid supply system 70 and the apparent liquid amount.

The unit capacity error acquisition part 134 of the consumption analysis part 130 in the management server 300 determines the unit capacity error between the sales unit capacity and the actual measured flow rate.

Furthermore, after the closing of the business, the overtime consumption acquisition part 136 of the consumption analysis part 130 in the management server 300 determines the overtime consumption of the liquid 20 based on the actual measured flow rate from the actual flow rate preparation part 110.

Then, the consumption analysis part 130 can send the information on the obtained difference, the unit capacity error, and the overtime consumption together with the time information to such as the analysis device 200 (computer) on the beer manufacturer via the communication line 160.

In accordance with the liquid sales management system 101 including the management server 300 that performs the operation described above, the following effects can be obtained.

That is, first, it is possible to perform the sales management of the liquid 20 in the management server 300 by focusing on the difference between the apparent liquid amount and the actual consumption of the liquid 20, and it is possible to perform the sales management of the liquid 20 in the analysis device 200 on the beer manufacturer via the communication line 160, for example.

It is possible to ascertain in every store the difference between the sales information in the sales information management system 250 and the actual consumption of the liquid 20, that is, the non-sale amount of the liquid 20 with the management server 300 and the analysis device 200 together with the time information.

It is possible to ascertain in every store the unit capacity error with the management server 300 and the analysis device 200, the unit capacity error corresponding to the difference between the sales unit capacity in one drinking container 40 and the actual measured flow rate of the liquid 20 actually dispensed into the drinking container 40, from the information on the unit capacity error between the sales unit capacity and the actual measured How rate determined by the unit capacity error acquisition part 134 of the consumption analysis part 130 in the management server 300. Thus, for example, the beer manufacturer can provide guidance to each store such that the loss on the store side or the customer side is reduced.

In the dispensing device 50, when an automatic dispensing device that automatically pours the liquid 20 into the drinking container 40 is used, it is possible to find out whether or not the setting of the sales unit capacity is appropriate. When the unit capacity error is large and the setting of the sales unit capacity is inappropriate, it is possible to prompt the user to correct the setting.

It is possible to ascertain in every store the overtime consumption of the liquid 20 after tire closing of the business determined by the overtime consumption acquisition part 136 with the management server 300 and the analysis device 200. That is, for example, the beer manufacturer can ascertain in every store whether or not the cleaning operation is performed whenever the business is closed by comparing the overtime consumption with the rough consumption of the liquid 20 involved in the cleaning operation.

Although it should not occur, when the store staff drinks secretly without anyone knowing it after the closing of the business, the overtime consumption greatly exceeds the normal amount of the liquid 20 involved in the cleaning operation. Thus, for example, the beer manufacturer can ascertain in every store whether or not the store staff drinks secretly without anyone knowing it by comparing the overtime consumption with the consumption of the liquid 20 involved in the cleaning operation.

As described, above, in accordance with the liquid sales management system 101 according to the present embodiment, it is possible to reduce the non-sale amount of the liquid 20. Accordingly, it is possible to greatly contribute to the improvement of the profit of each store.

### Second Embodiment

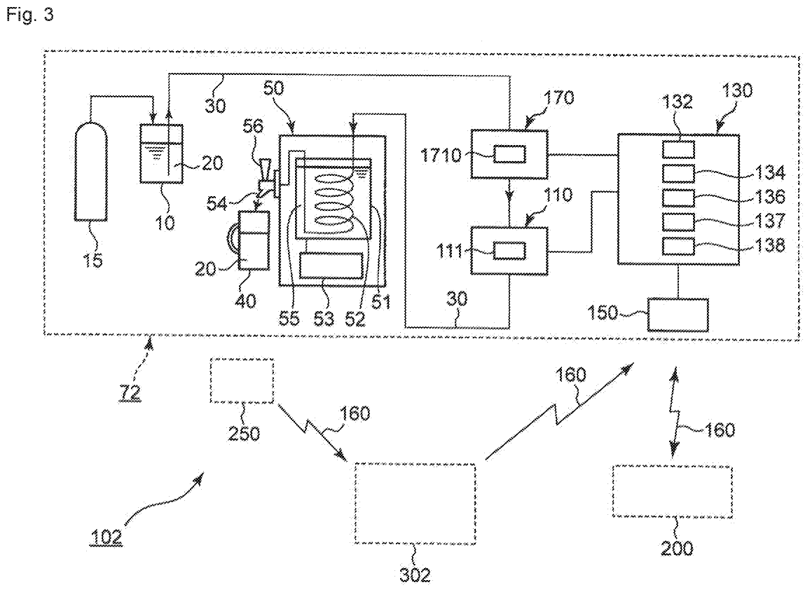

Next, a liquid sales management system 102 according to a second embodiment illustrated in FIG. 3 will be described.

It has been described in the liquid sales management system 101 according to the first embodiment that the consumption analysis part 130 is provided in the management server 300. Meanwhile, in the liquid sales management system 102 according to the second embodiment, the following configuration is adopted: The consumption analysis part 130 is provided on the liquid supply system (referred to as a liquid supply system 72 in the second embodiment) side, and information determined by the consumption analysis part 130 is transmitted from the transmission and reception part 150 via the communication line 160 to, for example, the analysis device 200 on the beer manufacturer. The management server is referred to as a management server 302 in the second embodiment.

The configuration and operation of the consumption analysis part 130 are the same as those in the case of the liquid sales management system 101 according to the first embodiment.

In the liquid supply system 72, the actual flow rate preparation part 110 is electrically connected to the consumption analysis part 130, and the consumption analysis part 130 is electrically connected to the transmission and reception part 150.

Similarly to the management server 300, the sales information is supplied to the management server 302 from the sales information management system 250, and the management server 302 supplies the sales information to the consumption analysis part 130 via the communication line 160 and the transmission and reception part 150 in the liquid supply system 72. The transmission and reception part 150 in the liquid supply system 72 performs information communication with the analysis device 200 via the communication line 160.

Thus, the information determined by the consumption analysis part 130 can be supplied to the analysis device 200.

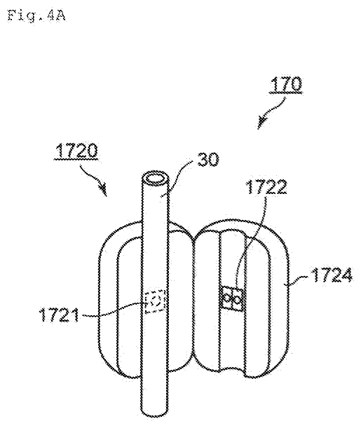

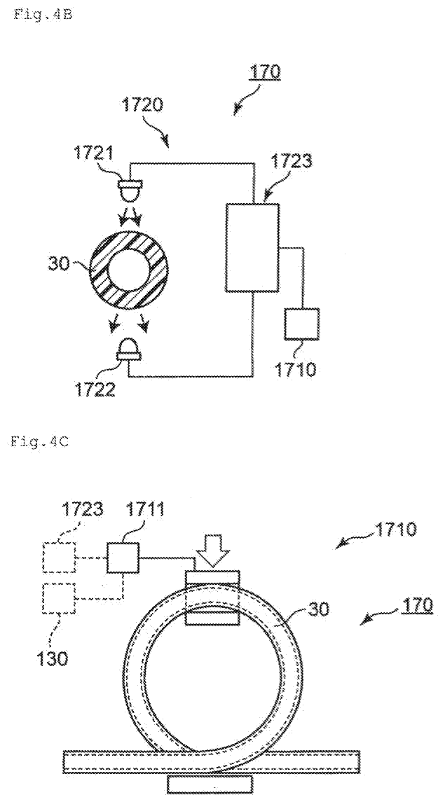

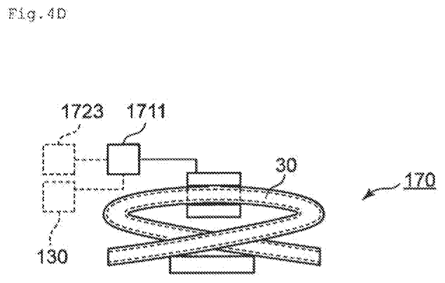

The liquid supply system 72 includes a fluid flow path adjustment device 170 as illustrated in FIG. 3. The fluid flow path adjustment device 170 will be described with reference to FIGS. 4A to 4D.

The fluid flow path adjustment device 170 is a device as disclosed in, for example, JP 5649801 B of the applicant of the present invention, and is a device that is mounted with respect to the supply pipe 30, and prevents a carbon dioxide gas which is a pressurized gas from being ejected from the liquid dispensing outlet 54 of the dispensing device 50 when the liquid 20 within the container 10 is exhausted (when the storage container 10 is empty) while the liquid (beer) 20 is being dispensed from the liquid dispensing outlet 54 to the drinking container 40 and when the storage container 10 is replaced.

In order to prevent such ejection of the carbon dioxide gas, the fluid flow path adjustment device 170 includes a fluid stopper device 1710 and a detection part 1720. As illustrated in FIGS. 4A and 4B, the detection part 1720 includes a light emitting element 1721, a light receiving element 1722, and a liquid state determination part 1723. The light emitting element 1721 and the light receiving element 1722 are positioned at a housing 1724 in the fluid flow path adjustment device 170, the housing being arranged so as to sandwich the resin supply pipe 30 within the fluid flow path adjustment device 170, and the elements being arranged to be opposed to each other across the beer passing through the supply pipe 30. The light emitting element 1721 emits infrared light, and the light receiving element 1722 receives the emitted infrared light. The light emitting element 1721 and the light receiving element 1722 are electrically connected to the liquid state determination part 1723 that detects the state of the passing liquid (beer) 20. That is, a refractive index of the light traveling from the light emitting element 1721 to the light receiving element 1722 varies depending on whether an object passing through the supply pipe 30 is a liquid, gas, or a mixture thereof. Therefore, the amount of light received by the light receiving element 1722 varies depending on the object passing through the supply pipe 30. The liquid state determination part 1723 detects a change in the amount of received light, and activates the fluid stopper device 1710 when the passing object becomes gas.

As illustrated in FIGS. 4C and 4D, the fluid stepper device 1710 includes, as a configuration example, the supply pipe 30 arranged in a loop shape, and a movement mechanism 1711 for moving a holding part that holds the supply pipe 30. The movement mechanism 1711 moves the supply pipe 30 in an arrow direction with the control of the liquid state determination part 1723, and thus, a flow path is blocked by bending and crushing the supply pipe 30. The supply pipe 30 of which the flow path is blocked is returned by the movement mechanism 1711.

The fluid flow path adjustment device 170 having such a configuration and operation may be electrically connected to the consumption analysis part 130, and the fluid stopper device 1710 in the fluid flow path adjustment device 170 may be controlled by the consumption analysis part 130.

In the operation control using the consumption analysis part 130, the operation of the fluid stopper device 1710 may be controlled by the consumption analysis part 130 according to the information received by the transmission and reception part 150.

Since the cleaning operation in the liquid supply system 72 is performed with the fluid flow path adjustment device 170 turned off, the turning-off operation of the fluid flow path adjustment device 170 may be utilized as an indication of determining whether or not the cleaning operation is performed.

In the liquid sales management system 102 having such a configuration, the same effects as those in the case of the liquid sales management system 101 can be obtained.

That is, the consumption analysis part 130 in the liquid supply system 72 can perform the sales management of the liquid 20 by focusing on the difference between the apparent liquid amount supplied from the management server 302 via the communication line 160 and the actual consumption of the liquid 20 supplied from the actual flow rate preparation part 110. Thus, the sales management of the liquid 20 can be performed in the analysis device 200 via the transmission and reception part 150 and the communication line 160.

The non-sale amount of the liquid 20 and the unit capacity error together with the time information can be ascertained for every store in the analysis device 200. Thus, guidance or the like to the store can be performed. It is possible to recognize whether or not the setting of the sales unit capacity is appropriate in the case of using the automatic dispensing device.

It is possible to ascertain in every store whether or not the cleaning operation is executed whenever the business is closed, and it is possible to ascertain in every store whether or not the store staff drinks secretly without anyone knowing it.

As described above, the liquid sales management system 102 according to the present, embodiment can reduce the non-sale amount of the liquid 20. Accordingly, it is possible to greatly contribute to the improvement of the profit of each store.

The fluid flow path adjustment device 170 described in the second embodiment can be provided in the liquid supply system 70 in the liquid sales management system 101 according to the first embodiment. In this configuration, although it has been described in the first embodiment that the tone information from the time information generation part 132 is used for determining whether or not the cleaning operation is performed, the turning-off operation in the fluid flow path adjustment device 170 can be used as an indication of determining whether or not the cleaning operation is performed, instead of or in combination with the time information.

It is also possible to adopt a configuration in which the configurations in the embodiments are combined.

In each embodiment, “electrically connected” means a concept that, includes not only wired connection but also wireless connection.

Although the present invention has been fully described in connection with preferred embodiments thereof with reference to the accompanying drawings, various changes and modifications will be apparent to those skilled in the art. It is to be understood that such changes and modifications are intended to be included therein without departing from the scope of the invention as set forth in the appended claims.

All the disclosure contents of the specification, drawings, claims, and abstract of Japanese Patent Application No. 2018-000044 filed on Jan. 4, 2038 are incorporated herein by reference.

### INDUSTRIAL APPLICABILITY

The present invention is applicable to a liquid oaks management system that performs sales management of a liquid in a liquid supply system.

### DESCRIPTION OF REFERENCE SYMBOLS

10 STORAGE CONTAINER
30 SUPPLY PIPE
40 DRINKING CONTAINER
50 DISPENSING DEVICE
54 LIQUID DISPENSING OUTLET
70, 72 LIQUID SUPPLY SYSTEM
101, 102 LIQUID SALES MANAGEMENT SYSTEM
110 ACTUAL FLOW RATE PREPARATION PART
111 FLOW RATE SENSOR
130 CONSUMPTION ANALYSIS PART
134 UNIT CAPACITY ERROR ACQUISITION PART
136 OVERTIME CONSUMPTION ACQUISITION PART
150 TRANSMISSION AND RECEPTION PART
160 COMMUNICATION LINE
170 FLUID FLOW PATH ADJUSTMENT DEVICE
171 FLUID STOPPER DEVICE
250 SALES INFORMATION MANAGEMENT SYSTEM
300, 302 MANAGEMENT SERVER

1. A liquid sales management system comprising a liquid supply system in a store, a sales information management system in the store, and a management server communicating with the liquid supply system and the sales information management system via a communication line,
the liquid supply system including:
a dispensing device configured such that a liquid within a storage container is supplied with pressurization through a supply pipe, configured to cool and dispense the liquid to a drinking container;
an actual flow rate preparation part configured to have a flow rate sensor detecting an amount of the liquid dispensed into the drinking container and to determine a actual measured flow rate of the liquid dispensed into the drinking container from the dispensing device; and
a transmission and reception part configured to communicate with the communication line,
the sales information management system corresponding to a system configured to send sales information of the liquid to the communication line, the sales information being information with which pieces of information of a sales unit capacity corresponding to a prescribed capacity per one sale, the number of sales, and a sales time are associated, and
the management server including a consumption analysis part configured to determine a difference between an apparent liquid amount determined from the sales information and the actual measured flow rate, the difference corresponding to a non-sales amount of the liquid which is not involved in sales.

2. The liquid sales management system according to claim 1,
wherein the management server further includes an overtime consumption acquisition part configured to determine an amount of liquid consumed after the sales time is ended, as an overtime consumption.

3. The liquid sales management system according to claim 2,
wherein the overtime consumption acquisition part is configured to subtract a known consumption of the liquid consumed by one cleaning operation for the liquid supply system from the overtime consumption.

4. The liquid sales management system according to claim 1,
wherein the management server further includes a unit capacity error acquisition part configured to determine a difference between the sales unit capacity and the actual measured flow rate, as a unit capacity error.

5. The liquid sales management system according to claim 1, further comprising:
an analysis device configured to be provided in a liquid manufacturer and to communicate with the communication line.

6. A liquid sales management system comprising a liquid supply system in a store, a sales information management system in the store, and a management server configured to perform communication via a communication line and to store information from the liquid supply system and the sales information management system,
the sales information management system corresponding to a system configured to send sales information of the liquid to the communication line, the sales information being information with which pieces of information of a sales unit capacity corresponding to a prescribed capacity per one sale, the number of sales, and a sales time are associated,
the liquid supply system including:
a dispensing device configured such that a liquid within a storage container is supplied with pressurization through a supply pipe, configured to cool and dispense the liquid to a drinking container;
an actual flow rate preparation part configured to have a flow rate sensor detecting an amount of the liquid dispensed into the drinking container and to determine a actual measured flow rate of the liquid dispensed into the drinking container from the dispensing device;
a transmission and reception part configured to communicate with the communication line, and
a consumption analysis part configured to determine a difference between an apparent liquid amount determined from the sales information obtained from the management server and the actual measured flow rate, the difference corresponding to a non-sales amount of the liquid which is not involved in sales.

7. The liquid sales management system according to claim 6, further comprising:
an analysis device configured to communicate with the communication line.

8. The liquid sales management system according to claim 1,
wherein the liquid supply system further includes a fluid flow path adjustment device configured to be mounted with respect to the supply pipe and including a fluid stopper device configured to stop the dispensing of the liquid from the dispensing device.

9. The liquid sales management system according to claim 6,
wherein the liquid supply system further includes a fluid flow path adjustment device configured to be mounted with respect to the supply pipe and including a fluid stopper device configured to stop the dispensing of the liquid from the dispensing device.
